(19) United States
(12) Patent Application Publication
(10) Pub. No.: US 2006/0117294 A1
(43) Pub. Date: Jun. 1, 2006

(54) System and method for executing and building a software application

(75) Inventor: Michel Vogler, Amsterdam (NL)

Correspondence Address: SUGHRUE MION, PLLC, 2100 PENNSYLVANIA AVENUE, N.W., SUITE 800, WASHINGTON, DC, 20037, US

(73) Assignee: Crossmarx B.V., GD Amsterdam (NL)

(21) Appl. No.: 10/525,382

(22) PCT Filed: Aug. 29, 2003
(86) PCT No.: PCT/NL03/00606

§ 371 Date: Sep. 7, 2005

(30) Foreign Application Priority Data
Aug. 29, 2002 (WO) PCT/NL02/00569

(51) Int. Cl. G06F 9/44

(52) U.S. Cl. 717/104; 717/101; 717/120

(57) ABSTRACT

System and method for building a software application by defining an application specification (10) which allows execution of the software application by entering the application specification (10) in a generic application engine (5) running on a computer system. To this end, the application specification (10) comprises a specification (7) of a plurality of data classes, a data class being a description of objects relevant within the software application, the plurality of data classes forming a structure by means of relations, a specification of at least one user group of the software application, a user group being defined as a group of users having common roles with regard to the software application, and an assignment of permissions to the at least one user group with respect to the plurality of data classes.

The present invention relates to a system and a method for executing a software application. Furthermore, the present invention relates to a system and method for building a software application.

In present systems and methods for building software applications, either a standardised software package is bought by a company, and its business processes adapted to the software package or a software application is designed, programmed and tested to suit the specific needs of a company. In the first case, such a software package lacks flexibility in use, is often difficult to integrate into existing systems and usually offers too much, too little or the wrong functionality. In the second case, the complete software development before operational use is often long and expensive.

Principal to these known software development strategies, is that it involves programming and testing of software code. Different specialists with different competencies are involved in a sequential, and often also iterative, manner before an operational software application is obtained. This requires large investments, both in time and cost.

Another example is disclosed in the international patent application WO01/014962, which describes a method and apparatus for providing custom configurable business applications from a standardized set of components. In this method and apparatus, a modular set of components are used to construct a business service application according to user requirements. The modular set of components comprise business steps (operations with a defined set of input and output ports), and business rules (which capture customer specific business practices). In this case, the components are thus adapted to a specific business service application. Therefore, this approach still requires a great deal of detailed programming, and does not offer the advantages as described in this present invention.

The present invention seeks to provide a system and method for building a software application which shortens the time to operational use of a software application, and provides a better cost efficiency for delivering an operational software application.

The foundation of such a system and method is described in pending patent application PCT/NL01/00926, of the same applicant as the present patent application.

According to a first aspect of the present invention, a system is provided for executing a software application comprising a computer system connected to a plurality of input/output interfaces and a database, the computer system being arranged for implementing a generic application engine and for receiving an application specification as input for the generic application engine, which generic application engine is connected to the plurality of input/output interfaces and to the database, the generic application engine being arranged to use a set of functional components, such as database operations, logical operations, presentation functions, user input/output interfaces, logging and monitoring, to convert the application specification into the software application, the application specification comprising:

a) a specification of a plurality of data classes, a data class being a description of objects relevant within the software application, and the plurality of data classes forming a structure by means of relations;

b) a specification of at least one user group of the software application, a user group being defined as a group of users having common roles with regard to the software application; and

c) an assignment of permissions to the at least one user group with respect to the plurality of data classes.

An application specification is an abstract, but exact, specification of a software application. This can be a software application in any state, e.g. a software application that is already running, or a software application to be built. The specification is ‘abstract’, because it concentrates on data classes, user groups and permissions. It can define a complete software application without having to mention user interface details. The specification is ‘exact’, because it sufficiently describes a software application to allow the generic application engine to generate the complete operational software application. An application specification is usually the result from an information analysis, but can also be (partly) derived from reading meta data of an existing database.

In this description of the invention, the focus is on a “black box” generic application engine. In this style of operation, the application specification is loaded into a generic application engine, after which the generic application engine executes the desired behaviour of the software application. However, in an alternative style of operation, the process can be subdivided in separate steps. First, executable software code is created from (parts of) the application specification (in any programming language). In a second step this generated software code may even be modified by a human programmer in order to change functionality and/or appearance. Finally, the generated (and possibly modified) software code can run, possibly together with standard components of the generic application engine. In this style of operation, the original application specification can still be used to control the behaviour of the software application. This alternative style of operation delivers more control to the programmer, and provides more possibilities to adapt the software application

The alternative style of operation can be implemented, using the same application specification as in the first style, and producing software code that, when executed, provides the same functionality as in the first style. There are several ways to generate software code from the application specification, mainly dependent on the desired relation between the generated code and the standard components. Since the concept of code generation from a model is common in the field, this style of operation is not described in further detail. From the description of the first style, it will be apparent to the person skilled in the art, how to create an implementation of the alternative style.

The term ‘data class’ as mentioned in this description, refers to a ‘class’ in standard object oriented modelling (usually a class is known as a description of objects having common characteristics). However, the essentials of this description and this invention can also be applied on ‘entities’ as they are known in the area of conventional data modelling

The term ‘relation’ as mentioned in this description refers to a structural relationship between two data classes, commonly known as an ‘association’ (e.g. see Unified Modeling Language). Each relation also has ‘multiplicity’, which is an indication of how many objects may participate at either end of the relation. The most common multiplicities are 1, * (0 to infinity), and 0.1 (either none or one). The relations themselves might be of type: one-to-one, one-to-many or many-to-many, as is commonly known in the area of entity relationship modelling.

When two data classes are related, the data class on the one-side of the relationship (if any) is called the ‘foreign class’, while the data class on the many-side of the relationship (if any) is called the ‘connected class’. A connected class usually has multiplicity *, with respect to this relation. A foreign class usually has multiplicity 0.1 or 1 with respect to this relation. At run time the relationship will lead to related objects. An object of the foreign class is called ‘foreign object’, while an object of the connected class is called ‘connected object’. When a data class A has a connected class B, and class B has a connected class C, then C is an indirect connected class of A.

The term ‘user’ as mentioned in this description may be understood as being an individual user, interacting with the software application via a (graphical) user interface (input and output), or a further software or hardware application (using appropriate interfaces). In simple software applications, there may be one single user group, being an anonymous or default user group.

In a further aspect, the present invention relates to a system for building a software application comprising an input/output device, memory means and processing means connected to the input/output device and memory means, the processing means being arranged for defining an application specification, using the input/output device, and to store the application specification in the memory means, which application specification can be input in a system for executing a software application according to the present invention. Such a system, also referenced as work bench or specification editor, allows to create an application specification for input to the generic application engine in order to create the software application.

In an even further aspect, the present invention provides a method for executing a software application comprising inputting an application specification into a generic application engine, which generic application engine is connected to a plurality of input/output interfaces and to a database, the generic application engine being arranged to use a set of functional components, such as database operations, logical operations, presentation functions, user input/output interfaces, logging and monitoring, to convert the application specification into the software application, the application specification comprising:

a) a specification of a plurality of data classes, a data class being a description of objects relevant within the software application, and the plurality of data classes forming a structure by means of relations;

b) a specification of at least one user group of the software application, a user group being defined as a group of users having common roles with regard to the software application; and

c) an assignment of permissions to the at least one user group with respect to the plurality of data classes.

According to an even further aspect of the present invention, a method is provided for building a software application comprising defining an application specification and storing the application specification, which application specification is arranged to be used in a method for executing a software application according to the present invention.

With the systems and methods according to the present invention, it is possible to develop an operational software application to suit specific needs by only specifying the functionality of the software application. The software application is built, with considerably less detailed programming. This also allows for easier maintenance and future upgrades, as only the application specification needs to be updated.

The application specification used in the present invention serves various targets. First, it can be entered in the generic application engine to create the running software application. Secondly, from the application specification scripts can be derived to create or modify the database structure that is used to store the application's data. Moreover, the application specification may be useful in other areas, such as management and support or other organisational areas, e.g. education and training.

The present invention thus allows to make a software application with any usual functionality of a modern software application on a variety of fields, such as archiving, call centre applications, workflow, customer relationship management, e-commerce, content management, etc. The present system and method are particularly advantageous when using (multiple) databases with complex data models, when using various user groups with different authorisations, or when using deduction rules.

The generic application engine comprises functionality which is often present in software applications, i.e. database operations, business logic/rules, presentation functions, user input/output interfaces, logging and monitoring. The generic application engine uses known technical standards, such as SQL, XML, XSL, JAVA, HTTP, SOAP.

The generic application engine allows to select data, read data, lock data, join data, sort data, insert data, copy data, update data and delete data in a database, to import and export data from/to files, such as XML-files, and to synchronise database copies. Business logic can be supported and executed in several ways. Deduction rules (formulas, etc.) may be automatically executed in order to deduce data. Validation rules can be executed to validate user input. Additional constraints might be used to create specific selections of data or lookup lists. Event triggers can be used to implement work flows. Finally, specific procedures can be implemented that can be executed on user requests.

For presentation of data on a screen, the generic application engine uses various screen layouts, such as tree, tabular and cross table representations. Data may be selected, presented (e.g. using simple graphics), modified and uploaded. Other input and output is possible using the generic application engine, e.g. using interfaces to send and receive e-mail, faxes, sms, etc., read and write files (txt, xml, csf), or exchange data with other programs, e.g. using HTTP, CORBA or SOAP. Also, the generic application engine is arranged to log all use of the software application, and to process the logged data.

The term ‘select’ in this description refers to the action of constructing criteria, and applying these criteria on a data class in order to get a subset of objects. The values of one or more fields of the selected objects are presented in a list or table. The term ‘select’ can be exchanged by the term ‘search’. From this list or table the other details of each object can be accessed. e.g. by selecting a row and/or activating a button.

The terms ‘modify’ and ‘modification’, used in this description in relation to data objects, refer to one or more of the following actions: insert, copy, delete and update. The term ‘update’ only refers to altering values of fields of existing objects.

In the area of data processing, other systems and methods are present, trying to cope with the same problems. Common in the field is the automatic construction of simple user interfaces for selecting, reading and editing data of one data class, derived from a data model. However, none of these methods and systems is as extended as the present invention. The present invention creates the possibility to deliver complete software applications, with a set of interrelated input/output devices, e.g. screens, each screen having integrated functionality for more than one data class (e.g. provided with trees or tab panels), and providing exact functionality for different users (based on roles and/or permissions), without having to specify the input/output devices themselves. The present invention offers these possibilities (that other methods and systems do not offer) by only combining a carefully considered and well-thought-out structure for an application specification with a smart and stable generic application engine. This innovative system and method for creating (enterprise-wide) software applications is new in the area of data processing.

In an embodiment of the present invention, a data class hierarchy is defined in the application specification by specifying an extended data class as comprising one or more inherited characteristics of an associated super data class. The use of data class hierarchy increases the specification power of the generic application engine, and allows for faster development and easier maintenance of software applications.

In an embodiment of the present system or method, the application specification comprises for each of the plurality of data classes a specification of a plurality of fields, each field representing an element for storing data values related to an object.

In an even further embodiment of the present invention, a field hierarchy is defined in the application specification by specifying an extended field as comprising one or more inherited field characteristics of an associated super field. As it is not needed to specify all fields of data classes completely, development of software applications can be faster, and maintenance can be easier.

In a further embodiment of the present system or method, the application specification may comprise for each of the plurality of data classes a specification of a plurality of categories, which can be used to structure all data related to an object. This structure is used by the generic application engine to present data to the user in a comprehensible way.

In another further embodiment, the application specification may comprise a specification of a plurality of domains, a domain being a list of lookup values that can be referenced to from the specification of fields. Domains are used to simplify selecting, reading and modifying objects.

According to an even further embodiment, for a specific combination of user group and data class, or a specific combination of user group and field, the permissions are chosen from the set of: select permission; export permission; read permission; update permission; insert permission; copy permission; delete permission. The value of each permission is one of the group of: no; yes; follow foreign object; own; constraint. This allows to define the interrelationship between user groups and data classes and/or fields in a sufficient scope to be able to develop various software applications.

In a further embodiment, the application specification comprises a computational specification for describing further computational parts of the software application. Certain software applications require additional logical operations on their data, which can not be specified using the application specification as described above. In this embodiment, a more broad spectrum of possible software applications may be developed using the present inventive system and method.

The application specification may in a further embodiment comprise an appearance specification for defining non-functional parts of the software application, such as user interface parts. The generic application engine includes standard input/output of data from the software application. Using an appearance specification, the layout of the presented data may be altered and specified to specific user needs.

Further advantageous embodiments are given in the other dependent claims.

A further aspect of the present invention relates to a computer program product comprising computer readable code, which allows a computer when loaded with the computer readable code to implement a generic application engine as used in the system or method according to the present invention. This allows the software code of the generic application engine to be distributed to other computer systems, e.g. using a data carrier such as a CD, or using a computer network connection, such as the Internet.

An even further aspect of the present invention relates to a computer program product comprising computer readable code, which allows a computer when loaded with the computer readable code to define an application specification which is adapted to be entered in a generic application engine running on the computer, the application specification comprising:

a) a specification of a plurality of data classes, a data class being a description of objects relevant within the software application, and the plurality of data classes forming a structure by means of relations;

b) a specification of at least one user group of the software application, a user group being defined as a group of users having common roles with regard to the software application; and

c) an assignment of permissions to the at least one user group with respect to the plurality of data classes.

This will allow to provide a computer with the ability to build the application specification necessary to execute the software application.

The present invention will now be described in further detail using a number of exemplary embodiments, with reference to the attached drawings, in which:

FIG. 1 shows a schematic view of the execution environment of a software application according to the present invention;

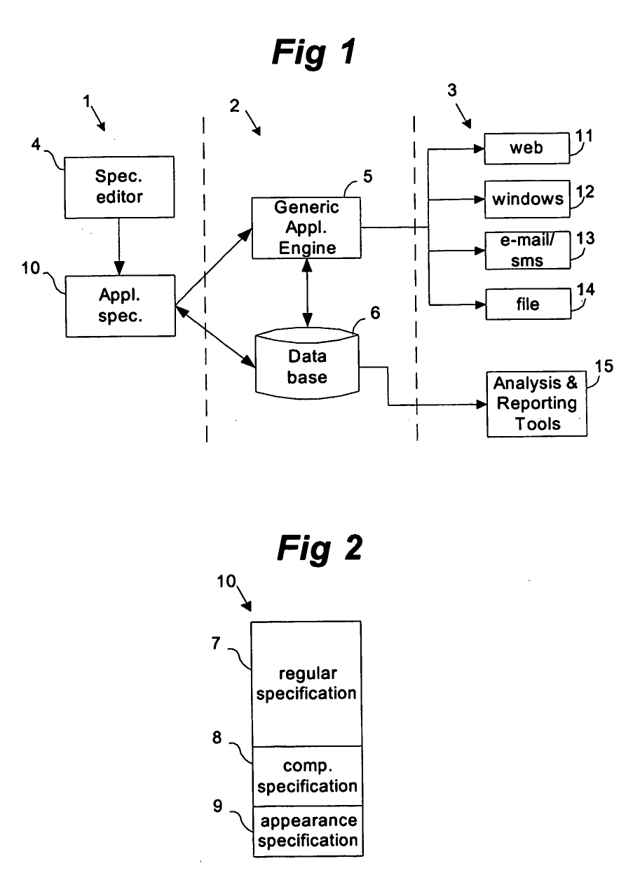

FIG. 2 shows a schematic view of the composition of an application specification according to an embodiment of the present invention;

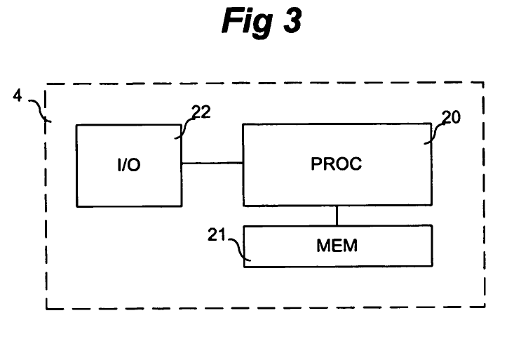

FIG. 3 shows a schematic view of a system used in the present invention to build a software application.

In FIG. 1, a schematic view is shown of the execution environment of a software application according to an embodiment of the present invention. The schematic view shows three parts of the software application environment, the development part 1, the run-time execution part 2 and the input/output part 3.

A software application is developed according to the present invention using a specification editor 4 to analyse the software application and construct an application specification. The specification editor 4 produces the application specification 10, e.g. in the form of a XML file, in a manner to be discussed below.

The specification editor 4 may comprise a processor 20 with associated memory 21 and an input/output device 22, as shown schematically in FIG. 3. Of course, it will be apparent to the person skilled in the art that the specification editor 4 may be implemented using e.g. a computer, or other processing means and related peripheral equipment known in the art.

The heart of the software application execution is the generic application engine 5, running on a computer system. This generic application engine 5 provides the standardised functions which may be used by a software application. In combination with the application specification 10, the generic application engine provides the behaviour of the software application, using data residing in a database 6.

The generic application engine 5 is connected to a number of possible interfaces for input and output to a user. A user may be a human user, using a (graphical) user interface, or a further software or hardware system using appropriate interfaces. The human interface may be implemented in a variety of manners, of which some are shown in FIG. 1. A web interface 11 may be used to interact with the software application. Alternatively, a windows interface 12 may be used. Both alternatives may be used in an Internet or Intranet environment, or on a stand-alone (PC-based) system. Other user interfaces may be e-mail or sms interfaces 13, or even a file interface 14.

The database 6 which is being used by the software application, comprises data. These data may, in addition to being used by the software application according to the present invention, be used for other purposes, using analysis and reporting tools 15, which are known per se in the field of database processing.

FIG. 2 shows the composition of an application specification 10 according to an embodiment of the present invention. The application specification 10 comprises at least a regular specification 7, which defines the basis of a software application. For certain software applications, it is conceivable that the application specification 10 only comprises a regular specification 7. For other software applications, the application specification may comprise a computational specification 8, which can include additional functionality to a software application, such as flow charts, constraints and/or macro's. Finally, the application specification 10 may comprise an appearance specification 9, which defines application specific elements of the user interface.

The regular specification 7 may be assembled interactively using the specification editor 4. The core of the regular specification is formed by a definition of data classes and user groups, as well as the roles assigned to the user groups with respect to the data classes and their fields (see below), expressed in permissions.

Data classes are groups of objects which play a role in the software application. To design a software application, the first step is to translate the real world items in a model by means of analysis. This comprises identifying the data classes, normalizing the data classes (i.e. delete repetitive groups and redundancy) and identifying the relations between the data classes.

For the present system and method for building a software application, data classes are described in the application specification 10 using a number of characteristics, such as:
a name;
the name of the database and the name of the database table where data about actual objects are stored;
a parent data class;
order in which data classes are shown (if nothing is specified, data classes will be presented in alphabetical order).
a size of a data class;
a constraint specifying a subset;
a primary show field.

By identifying a parent data class (optional), a hierarchical structure of data classes can be defined. The role of this hierarchical structure is described in separate paragraphs below.

For this invention, an important characteristic of the data class is the size of the data class. This is the number of (expected) objects and determines the manner in which the data class is shown to the user. Options are: ‘none’, ‘small’, ‘medium’ and ‘large’.

Another main characteristic for the data class is the primary show field, which has to be one of the fields of the data class. The primary show field allows an object to be discriminated from other objects by a user, better than the technical key of an object. The value in this field will be used as a label in a tree representation of an object. The primary show field is also important in relations between objects. Suppose that a data class A comprises a field F, which defines a relation to (the key field of) foreign class B. At runtime there can be an object a of data class A, having a relation to an object b of data class B. This means that the actual value of field F in object a is the value of the key field of object b. However, when object a is shown to a human user, the value of the primary show field of object b is shown as the value of field F, because this usually makes more sense to a human, than the value of the (technical) key field of object b.

In case of a many-to-many relationship between data classes, an intermediary data class is specified, and marked as a ‘relation class’ (also known as an ‘association class’ in object oriented modelling). A relation class has no fields, it only has two connected classes. Data about objects in a relation class is stored in a specific system table, that does not have to be specified.

For each data class categories can be specified. Categories group data which are related to a data class. This can relate to fields (see below) or other data classes which are linked to the current data class. On output devices, such as screens, categories may be shown as paragraphs, as nodes in a tree, as separate tab sheets in a collection of tab sheets, as independent screens, etc. In another form of output (in a text file or on a printer) categories can be shown as paragraphs.

Categories are included in the regular specification 7 with a number of characteristics, such as:
a name;
a content type of the category;
a content class;
order in which categories are shown (if nothing is specified, categories will be presented in alphabetical order);
a presentation type: values may be: ‘as paragraph’, ‘in tree’, ‘on tab’ or ‘own window’. When no presentation type is specified, the generic application engine chooses ‘on tab’ as default.

There are two possible content types: ‘fields’, which means that the category comprises fields that are associated with the data class; or ‘connected objects’, which means that the category comprises the related objects of a connected data class.

A content class has to be specified only when the content type is ‘connected objects’. The content class specifies from which data class the objects have to be selected. As content class can be chosen: a connected class of the current data class, or a data class that is connected to the current data class by means of a relation class. In all descriptions below, a data class that is connected through a relation class, is handled in the same manner as a regular connected class.

For each data class a number of fields can be specified. Fields are used as the basic elements for storing data within a software application. For each field characteristics may be specified, such as:
a name;
a long label (the long label being shown when fields are presented one at each row);
a short label (the short label may be used as column header when objects are presented in a tabular form);
a data type, such as string, integer, graphic;
an indication that the field is part of the technical key, which allows the unique identification of objects;
a description of the field;
input instructions for the field (instructions for inserting or updating values);
order in which fields are shown (if nothing is specified, fields will be presented in alphabetical order);
a domain (see below);
a foreign class and, if needed, a foreign field (see below);
a deduction rule (as a computational specification 8);
a dynamic lookup list (as a computational specification 8);
the name of the database column where the value of this field is stored (this column should be part of the database table as specified for the current data class);
a parent field, a function and/or a relation (see the paragraph on field hierarchies below)

To define one-to-one or one-to-many relationships between data classes, a field may comprise an identification of a foreign class. The foreign class has to be one of the other data classes as described in the application specification. As a result, the current data class will become a connected class of the data class that is specified as the foreign class. A foreign field might be specified too. When no foreign field is specified explicitly, the primary key field of the foreign class is the foreign field implicitly. The foreign field of the objects of the foreign class holds the possible values for the current field. Such a mechanism is usually known as a ‘foreign key constraint’ or ‘referential integrity’. The kind of relationship (one-to-one or one-to-many) is specified by specifying the multiplicity.

In addition to the above mentioned characteristics, for each field, its role in the user interaction can be specified, e.g.:
It can be specified whether the field can be used for creating selection criteria when searching or selecting objects from the data class. A field can set to be a ‘primary selection field’, which means that the field is shown directly to be used in selection criteria when searching for objects of the data class. A field can set to be a ‘secondary selection field’ when the field can be chosen from a pick list in second instance before it can be used for creating selection criteria.
The field can be linked to a category. The category must be one of the categories of the current data class, or a default category.
It can be specified whether the field will be shown as a column when the objects of the data class are represented in a table.
It can be specified whether the field can be used in a cross table representation, including the role: as columns, as rows, or as cell content.

A unique feature of this invention is the powerful usage of hierarchies in the application specification and in the generic application engine. In the application specification, two types of hierarchies might be used: class hierarchies and field hierarchies. Class hierarchies arise as soon as a data class is set as a parent of another data class, making the other data class a child from the first one. In the remaining, the parent is called ‘super class’, the child is called ‘extended class’. Field hierarchies arise as soon as a field is set as a parent of another field, making the other field a child from the first one. In the remaining, the parent is called ‘super field, the child is called ‘extended field’.

The main advantage of using class hierarchies is inheritance (similar to the usage of class hierarchies in Unified Modeling Language). In the system and method according to the present invention, all single characteristics of a super class are inherited by the extended class, except for the unique id and the name. However, all characteristics can be overwritten in the extended class; unique id and name are always overwritten.

In addition to the standard usage of inheritance, this invention introduces some new features of class hierarchies:
a. First, in the extended class, it can be specified explicitly:
   whether or not to inherit all fields from the super automatically
   whether or not to inherit only specific fields from the super automatically (e.g. only the fields that can be used in selection criteria or the fields that are shown as a column when objects are represented in a table)
   When fields are inherited automatically, these fields are called the ‘inherited’ fields of the extended class.
b. As described earlier, for each data class a number of fields can be specified. These fields are called the ‘declared’ fields. Declared fields ‘belong’ to that data class. An extended class can also have declared fields. The total of inherited fields and declared fields is called ‘associated fields’ or just ‘fields’.
c. As a result, extended classes can have two types of fields: inherited fields and declared fields. The generic application engine will combine the inherited fields and the declared fields for each extended class, and position them according to their presentation order.
d. Inherited fields inherit all characteristics of their ancestors in the super class. These characteristics can not be changed in the extended class. If a modification is needed, own fields have to be declared for the extended class (declared fields).
e. An extended class can be associated with a definition of a subset of objects of the parent class. If a subset is specified, the objects in this extended class are always the specified subset of objects of the parent class.
   The above mentioned aspects of class hierarchies in the present invention increases the specification power of the generic application engine, and allow for faster development and easier maintenance of applications.

One advantage of using field hierarchies is inheritance. In the system and method according to the present invention, an extended field inherits all single characteristics of its super field, except for the unique id and the name. However, some characteristics can be overwritten in the extended class; unique id and name are always overwritten.

A field can use almost every other field specified elsewhere in the application specification, as a super field.
a. The super field can be selected from the fields of the super class of the data class of the extended field (only when this data class has a super class).
b. The super field can be selected from the fields of any other data class in the application specification.
c. Usually, it makes no sense to let the super field be selected from the fields of the data class of the extended field. Therefore, this situation is not described here.

Domains may be defined separately in the application specification. Domains comprise allowed values for fields. E.g. a day indication of a date field will be limited to the values 1-31. A domain may be valid for multiple fields. For each domain an interval type has to be specified. An interval type may be ‘not ordered’, ‘discrete’ or ‘continuous’. The values in a domain having a ‘not ordered’ interval type, have no mutual relationship. This is usually the case in ‘string’ type data, e.g. ‘Paris’, ‘London’, ‘Berlin’. The values in a domain having a ‘discrete’ interval type have a mutual ordering, e.g. ‘1:bad’, ‘2:mediate’, ‘3:good’. Note that each domain value can comprise as key, such as ‘1’ and a label such as ‘bad’. The set of keys contain the allowed values for the field in actual objects. The label specifies the value as it will be presented to the human user. A ‘continuous’ interval type is like a ‘discrete’ interval type, but the domain is only used in select actions, not in modification actions. This means that the actual values of the fields in the objects are continuous. E.g. when the values in a domain with a ‘continuous’ interval type are ‘0:at the beach’, ‘0.1:close to the beach’, ‘1.0:not far from the beach’, the actual values of objects could be e.g. 0.2 or 0.8. However, users use the labels (e.g. ‘at the beach’) in select actions, instead of the numbers.

When a select action is performed with selection criteria containing a field with a discrete domain or a continuous domain (both are referred to hereinafter as ‘ordered domain’), the selection is performed in two steps. In a first step the criteria with a ‘not ordered’ domain are applied first, resulting in a subset of objects. In a second step the resulting subset is ordered by a score. For each object this score is (a function of) the distance between the desired value in the selection criterion for the field that has the ordered domain, and the actual value of the field of the object. If more than one field with an ordered domain is involved in the selection criteria, the total score for each object, will be the total of the individual scores for the fields.

User groups are groups of users (actual persons using a (graphical) user interface) or other software applications or hardware systems, which share the same permissions relating to data classes. User groups may also be modelled using hierarchical relationships (child-parent relations). Child user groups inherit the permissions of their parent user group.

Individual users of the software application are always known to the generic application engine as regular objects of a regular data class. This class is called the ‘user class’. The object representing the user (data) is called the ‘user object’.

Permissions, in the form of grants or authorisations, specify what a certain user group is able to do with certain data (and thus implicitly what they are not allowed). Permissions are stored in the regular specification 7 using permission matrices. Permissions may include:
select permission: specifies whether a user group is allowed to select objects of a data class, possibly also which fields may be used for the selection;
export permission: specifies whether a user group is allowed to export data about objects of a data class to file, possibly also which fields may be exported;
read permission: specifies whether a user group may read objects of a data class, possibly also which fields can be read;
update permission: specifies whether a user group may update objects of a data class, possibly also which fields may be updated;
insert permission: specifies whether a user group may insert new objects to a data class, or on field level, which fields may be entered in a new object. Once the object is stored, a new access to the object is governed by the update permission;
copy permission: specifies whether a user group may copy objects of a data class, and store the copy in the database;
delete permission: specifies whether a user group may delete objects of a data class.

On data class level all above mentioned permissions can be specified. On field level only the first five permissions can be specified. If a permission is specified on field level, this always overrules the specified permission on data class level.

The permissions in the permission matrices can have one of the following values:
no: the user group does not have the permission for the data class or the field;
yes: the user group does have the permission for the data class or the field;
‘follow foreign object’ (ffo): the permission is dependent on the permission which is valid for the current foreign object. The current foreign object is the last object that was selected by the user on the route to the current object (more formally, it is the object that was last added to the context, see below). The value ‘ffo’ may be useful in the case of multiple facts which may be considered as facts of a data class, but for which (for reasons of normalisation) a connected class has been created, e.g. when the e-mail addresses of a person have been grouped in a separate data class having fields ‘type’ and ‘address’. When a read permission has the value ‘ffo’, at run time the generic application engine uses the value which is valid for the read permission of the foreign object. When an update, insert, copy or delete permission has the value ‘ffo’, the generic application engine uses the corresponding value for the update permission of the foreign object. ‘ffo’ can not be specified for a select or export permission.
own: the permission depends on relations between the current user object and the current data object. The current data object is the object that is (going to be) read from a database (in case of a select permission) or is already loaded in the software application (in case of the other permissions). When ‘own’ is chosen as value, also the relationship(s) that express the ‘own’ relation have to be specified. E.g. the ‘own’ relation might be expressed as a direct relation from the user class to the current data class. In another case, both the user class and the current data class might have a relation to the same foreign class. All other relationships between classes can be used in the specification of the ‘own’ relation too. The generic application engine grants the current user the permission when the user object and the current data object actually are related according to the specified relationship(s).
constraint: the permission is governed by a specific constraint: for all objects for which the constraint is met, the permission is ‘yes’, for the others it is ‘no’. The constraint is defined in another part of the application specification, the computational specification 8 (see below).
   The combination of these five permission values is a unique feature of this invention and allows for faster development and easier maintenance of software applications.

One of the last steps in creating the regular specification is adding other basic functionality, e.g. user authentication, sending e-mails, registering incoming e-mails, etc. This is done by mapping the standard built-in functionality of the generic application engine to the relevant fields of the data model (e.g. the fields where user name and password are stored, respectively the e-mail field). In the area of component based development, this is known as ‘deployment’.

The computational specification 8, adding additional functionality to the software application, may comprise sequences, conditions and/or iterations. There are three kinds of computational specifications:
Flow chart: a flow chart is a structured manner to describe how the value of a variable may be deduced. Using sequences, conditions and iterations, the steps for determining the value of a variable are described. Each flow chart will result in the determination of the value of one or more variables (the output variables). A flow chart may be used to specify how a value of a field can be deduced from other data, like (other fields of) the current object, the context (see below) or the user object. A flow chart may also be used to specify how data modifications may be validated;
Constraints: a constraint is an expression which may be used to pose an additional restriction on objects of a data class. Such a constraint posed on a data class will result in a subset of all objects of that data class. A constraint may comprise multiple constraints combined by Boolean operators. A constraint can be used to specify how the content of a lookup list may be deduced dynamically, depending on the actual data and the user object. A second usage of a constraint can be the specification of a permission rule that can not be described in a matrix representation. Here again, the actual data and the user object can be used in the constraint specification;
Macro's: a macro is a collection of statements which may be executed in sequence, possibly accompanied by process logic (conditions and iterations). A macro may be executed in response to an action on an object. Then it is also called a trigger. Triggers may be defined when creating an object, when retrieving an object from a database, when updating a value of an object within the software application, when inserting, deleting or updating an object in a database, or when exporting an object to file. A macro may also be executed on request from a user.
   The main goal of the approach described here is to minimize the need for computational specifications, and maximize the possibilities of regular specifications. However, the generic application engine can be extended, when other types of computational specifications are needed.

One of the key elements of the current invention is the fact that from the application specification as described above, the generic application engine 5 is able to construct all interfaces, windows and screens that are used by users for interacting with the software application and its data. In the following, a description is given how the generic application engine 5 deduces the screens for user interaction from the application specification. A similar mechanism may be used for the program-to-program interface or for the output to text files or printers. Please note that in the previous paragraphs, some parts of the mechanism are already described. These parts are not repeated in the following.

In the current invention the generic application engine uses ready-to-use building blocks. The basic building block of a software application is a class manager. A class manager provides the functionality to present the objects from a data class in a simple, tree and/or tabular representation, to allow a user to select objects from the specific data class, to present the details of an object, and to modify objects. While updating values of objects, default values, input instructions, input aids and/or input validations can be applied.

A user can have direct access to all class managers for data classes he/she has select permission to. From the first class manager other class managers can be reached by hyperlinks or buttons.

A class manager always has one corresponding data class, called the ‘main class’. Besides objects from the main class, it can hold data from other data classes too. These other data classes are always (indirect) connected classes of the main class, specified with means of categories of content type ‘connected objects’.

The size of the main class determines how the class manager presents objects on a screen. When the size of the main class is ‘none’, then the data class contains no objects or fields, but only relations to connected classes by its categories. When the size of the main class is ‘small’, the class manager shows a tree at the left side of the screen. The top node of the tree will have a label like ‘All objects’. As child nodes, all objects of the data class are represented (with respect to read permissions) by their value of the primary show field. When the size of a data class is ‘medium’ or ‘large’, objects can only be found by searching. When the user selects such a data class, the class manager presents a screen to enter selection criteria. These selection criteria have to be constructed from the associated fields of the data class that are marked as a (primary or secondary) selection field. After applying these criteria, the objects that meet these criteria will be presented in a table, and from there, the details of each object can be accessed, e.g. by selecting a row and/or activating a button. The details will be shown in a new window. In a web interface, this can also be a new page in the current web browser (this also holds for the remaining of this description).

Also, the presentation type of a category as defined in the application specification determines the presentation. When at least one of the categories of a data class has the presentation type ‘in tree’, the generic application engine will show a tree on the left side of the screen. There are the following options:
The main class has size ‘small’. In this case, there already is a tree as described earlier.
The main class has size ‘medium’ or ‘large. In this case the uppermost node in the tree is the value of the primary show field of the current object.
The main class has size ‘none’. In this case the uppermost node in the tree is the name of the data class.

Whenever a node, representing an object (or the data class with size ‘none’) is selected, details are shown on the right side of the screen: first the fields of the default category, followed by the categories that have to be presented as paragraphs, followed by tab panels for each category which have to be presented on tabs. The presentation of a category itself depends on its content type. When the content type is ‘fields’, the fields associated with the category are shown, one at a row. The generic application engine will position them according to their presentation order. Each row starts with the long label of the field, followed by the value. When the content type is ‘connected objects’, a table will be shown with a row for every relevant object. The generic application engine will continuously check permissions, and will never show fields, columns or cells that the current user is not entitled to see.

The categories with presentation type ‘in tree’, will be shown as separate nodes under the nodes that are representing an object (or the data class with size ‘none’). The name of the category will be used as label.
Selecting a node that represents a category with content type ‘fields’, will show the fields of the category on the right side of the screen.
Selecting a node that represents a category with content type ‘connected objects’ will result in an empty right side of the screen. However as child nodes of this node, the user will find all related objects from the connected class as separate nodes. For all these objects, the same may be repeated.
   When there is no tree representation (there is no data class with size ‘small’, and there is no category with presentation type ‘in tree’), all categories will be presented in the same manner as described above.

Categories with presentation type ‘own window’ can be reached by activating a button. The content will be presented in another window.

The characteristics of the field may also influence the presentation on the screen. The long label of a field may be shown in front of the field value, as well as a possible description (e.g. as a tool tip) or a possible input instruction. The data type of a field determines the associated screen object. When a domain or a foreign class is specified, the field is usually represented using a lookup list. When the size of a foreign class is ‘large’, only the current value of the field is shown, accompanied by a button or link that brings the user to a search screen allowing to select a new object from the foreign class. As current value, the generic application engine uses the value of the primary show field.

From every row in a table representation, the user can visit all details from the data in that row, e.g. by selecting a row and/or activating a button. The details will be shown in a new window. When a field or table cell comprises a reference to a foreign object, this is automatically represented using a hyperlink, linking to the details of that object. These hyperlinks are only shown when the user has read permission on the foreign object.

Also, permissions determine the appearance of the software application. Depending on permissions of the current user, some (select) fields, or columns in tables will be shown and others not. Permissions are also applied on all objects and actions on objects. E.g. insert, delete, copy, or save buttons will show or hide automatically, according to the permissions. Fields and/or table cells are only editable when the user has update cq. insert permissions on the current object.

The generic application engine handles field inheritance as follows. In case of situation a (as described in the field inheritance paragraph), at runtime the extended fields are considered to be fields of the extended class. The generic application engine applies all inheritance rules automatically and the application will behave as if the extended field is a regular declared field. If an extended class contains both inherited fields and extended fields, there might be an extended field that extends from an inherited field. In this case, the generic application engine removes the inherited field from the extended class. A simple example illustrates this situation. Suppose you have a data class A with fields:
a1 (with presentation order 1),
a2 (with presentation order 2) and
a3 (with presentation order 3).
   Suppose you have another data class B, with data class A as super class. Data class B inherits all fields from data class A and has two declared fields of its own:
b1 (with presentation order 4 and without a super field), and
b2 (without a presentation order and with a2 as super field).
   Runtime this leads to the following order of fields for data class B:
a1
b2 (does not inherit the name, but does inherit the presentation order from a2)
a3
b1
   Note that in the case of situation a the behavior of the application could have been obtained without the use of field hierarchies. In this case, field hierarchies only allow for faster development and easier maintenance of applications. It is a very advantageous that it is no longer needed to specify all fields of data classes completely. Now they can be inherited and/or extended in different ways.

In case of situation b (as described in the field inheritance paragraph), at runtime the extended fields are shown on output devices, such as screens and reports, to be fields of the extended class, but in the background they are not. In the background, the fields belong to different data classes, that are interrelated. Therefore the generic application engine should know which relationship has to be applied between the current data class and the data class where the super field is declared. When no further specifications are given, the generic application engine tries to find the shortest (direct or indirect) applicable relation between the current data class and the data class where the super field is declared. How this is done exactly is not described here, since this will be apparent to the person skilled in the art. When no such shortest relation can be found uniquely, the applicable relation has to be specified in the application specification explicitly. The applicable relation is used in the following ways.
When the extended field is used for searching for objects, the relation is used to define additional constraints to the database query, usually using different tables (conform common relational database theory).
When the extended field is used for displaying data of objects in a table, the relation is used to create a join between objects of the current data class and objects of the data class where the super field is declared (conform common relational database theory). As a result from the join, the table might show more rows then there are objects in the current data class.
When the extended field is used for displaying details of a single object, the relation is used to create a join for all extended fields with a super field that belong to a foreign class. When the super fields belongs to a connected class, a function has to be specified also, like count, sum, average, max, min. The generic application engine applies this function on all connected objects on the values of the super field.
   Note that a simple join with connected objects is not possible, because this might result in more than one record. For a relation to connected objects, a function is always needed. For more complex relations between data classes, more complex mechanisms are needed, but these can be induced from the description so far. This will not be described here.
When the extended field is used for updating data, the user should be aware of the fact that he/she is not updating data of the current object, but updating data of one or more related objects. Updating an extended field, means updating data of related objects (this can be foreign or connected objects or even objects with an indirect relation to the current object). In case of connected objects, updating a field, means updating the values of all connected objects.
When the extended field is used for inserting objects in a database, the relation is used to create relations between the objects and store these relations in the database together with the objects (conform common relational database theory). Usually, there is one main object, and one or more related objects (foreign, connected or indirectly related objects). In case of extended fields with a super field that belong to the same connected class, the generic application engine assumes that all fields belong to the same object. From every connected class one object will be inserted (as long as field values are provided by the user). It is apparent that this mechanism can be extended, to create more connected objects simultaneously.
   Note that in the case of situation b, the behavior of the application could not have been obtained without usage of field hierarchies, or another mechanism. In this case this mechanism allows for specification and maintenance of powerful, user-friendly applications, without the need for programming or screen design. This is one of the unique features of this invention.

When an inherited field of an extended class is part of a category (that is declared in the super class), as a result this category is inherited automatically by the extended class. This leads to ‘inherited categories’. However, in the extended class, categories can be declared too. These are called ‘declared’ categories. The generic application engine will combine the inherited categories and the declared categories for each data class, and position them according to their presentation order. If an extended field inherits a section from its parent field, the generic application engine applies the same mechanism.

When a data class inherits fields, which happen to be foreign fields, and therefore make up one or more relations to one or more connected classes, as a result this data class inherits these relations too. When a data class has extended fields with super fields which happen to be foreign fields, and therefore make up one or more relations to one or more connected classes, as a result this data class inherits these relations too.

Here are two examples that illustrates how the generic application engine uses class hierarchies in the running application (without field hierarchies).

A) Inheritance of Connected Classes

Two classes in an application specification both might have the same connected class. E.g. the class person and the class organization both have the class address as a connected class. This can be realized as follows:
1. Specify a super class for both person and organization, i.e. actor. This data class does not need a database table.
2. Actor needs one field, that is the key field. Define a database sequence and a database column for this field.
3. Make the data class address a connected class of actor.
4. In person and organization, inherit all fields from their super (in this case, this is just the key field). As a result, the relation to address is inherited automatically.

Both data class person and data class organization now have a connected class address. In the database all addresses are stored in one database table, but every address has a unique relation to a person or an organization.

B) Views

In some cases you want to use a subset of objects from a class, e.g. for easy retrieval of your data or for lookup lists. This can be realized as follows:
1. First, create a constraint that specifies the subset.
2. Next, define a new data class and set the original data class as super class. This data class does not need a database table.
3. Inherit all fields.
4. Set the constraint on this new data class.

Now the generic application engine always presents users of this extended class only the objects that meet the constraint, either in a class manager or in a lookup list.

Here are three examples of how the generic application engine uses field hierarchies (without class hierarchies).

A) Using Extended Fields for Selecting Objects

In some cases, users might want to search for objects in the database, not only on their own fields but also on one or more fields of related objects (foreign objects or connected objects). This can be realized as follows:
1. Declare a new field in the current data class.
2. Set the field from the foreign or connected class as super field.
3. Specify the new field as a selection field (either as primary selection field or secondary selection field).

Now a user can also select objects that have a relation to one or more other objects that meets a certain constraint.

B) Using Extended Fields for Presenting Objects in Tables

In some cases, users might want to see objects from the database in tables, with as columns not only their own fields but also one or more fields of related objects (foreign objects or connected objects). This can be realized as follows:
1. Declare a new field in the current data class.
2. Set the field from the foreign or connected class as super field.
3. Specify the new field to be presented as column in a table.

Now tables contain not only the own fields of a data class, but also fields of related classes.

C) Using Extended Fields in Presenting Details of Objects

In some cases, users might want to see details of a single object, with as fields not only their own fields but also one or more fields of related objects (foreign objects or connected objects). This can be realized as follows:
1. Declare a new field in the current data class.
2. Set the field from the foreign or connected class as super field.
3. When the super belongs to a connected class, also a function has to be specified. The generic application engine will now also show additional data by extended fields.

Finally, two examples on how the generic application engine handles the combination of class hierarchies and field hierarchies.

A) Insert Only Forms

Class hierarchies also allow easy specification of special forms that are only used for data entry. These also include forms that are used on the Internet, e.g. for a request for information or ordering a product. These forms can be realized as follows:
1. Specify the form as a new data class. This data class does not need a database table.
2. Select the data class where most of the data of the form belongs to, and make this the super class for the new form.
3. Either inherit all fields from the super class or declare the fields for the form. Every declared field has to be an extended field, it needs to have a super field. Usually, the super field is a field from the super class, or a field from a connected or foreign class of the super class, but it might also be a field from another class. In case no applicable relation can be calculated automatically, the applicable relation has to be specified explicitly.

The generic application engine will take care that all data will be inserted in the right tables in the database. The relations between objects are created automatically. This allows for single forms where data for several tables can be entered.

B) Joins: Emulating a Many-to-Many Relation

In some cases, users of the application do not have to know that among the data classes, there are one or more intermediary classes, needed to implement logically many-to-many relations. These intermediary classes can be hidden as follows:
1. Define a new data class. This class does not need a database table.
2. Make one of the ends of the many-to-many relation (say the left end) the super class and inherit all fields.
3. Manually declare extended fields for all the fields in the intermediary class (every field in the intermediary class has to be a super field once).
4. In fact this defines a classic view (by a classic join). This new class can be used as connected class in a category of the class at the right hand of the relation.

Example: suppose there is a many-to-many relation between the class person and the class organization. Therefore an extra class relation has been created. By defining a join on organization and relation, details of the organization can be shown directly as connected objects of a person. If desirable, this view is updateable automatically.

As described above, the generic application engine automatically derives a presentation for all data and actions. However, all users are allowed to change the presentation, according to their own preferences. At runtime, they can sort tables, they can change the order of fields, they can change the presentation type of categories, they can hide or show columns in tables, etc., all with respect to the specified permissions. All modifications of the presentation can be stored for re-use.

In summery, after entering an application specification into the generic application engine, a software application is created that allow users to select (search), read (from simple, tree and/or tab representations), restructure (sort, join) and modify (insert, copy, delete and update) all data in the software application, exactly according to the user's permissions. This functionality is provided in a web interface (HTML) and/or in a windows interface.

Using a web interface, the appearance of the software application may be adopted to the user's need by using an appearance specification 9. The generic application engine creates all screens to be displayed to the user as XML documents (eXtended Mark-up Language). These XML documents may be transformed to HTML (HyperText Mark-up Language) using a XSL-document (eXtensible Style sheet Language) and/or CSS (cascading style sheets). With XSL, screen objects may be positioned or replaced and with CSS layout characteristics may be changed, such as background, colour and/or font.

The application specification may comprise a lot of other characteristics, which might be relevant for the actual realisation of the generic application engine, but, as such, these are not new and already known in the area of data processing. They are omitted from this description, since they will be apparent to the person skilled in the art.

Internally, every time a class manager is called from another class manager a context is passed. A context contains an ordered list of all objects which were passed by the user (in several class managers) to arrive at the present class manager from the starting point of the software application. Also the relations between the objects are stored in the context.

When a class manager is also holding data for connected classes, the current object of the main class (the ‘main object’) is also added to the context for all operations on objects of the connected classes. Also the relation from the current main object to the current connected object is added to the context.

When the class manager also holds objects of indirect connected classes, all intermediary objects and relations are also added to the context, for all operations on the objects of the indirect connected classes.

The user may decides to switch to another class manager, which shows details of an object or shows a category with presentation type ‘own window’. In these cases the context as constructed so far (with the list of objects and relations) is passed to the next class manager.

A class manager may use a context in different ways. First, a context can be used to apply additional constraints on objects (e.g. only showing objects which are valid within the present context). In order to define whether an object from a data class meets the constraints defined by a context, first all relations from this data class as connected class (multiplicity *) to the data classes in the context as foreign class (multiplicity 0.1) have to be listed (according to the application specification). An object meets the constraints, only if for all these relationships, there actually is a relation from this object to the objects in the context. This mechanism is applied when a class manager shows the connected objects of an object in a table or tree.

The context can also be used to apply additional constraints on lookup lists which are constructed from objects of a foreign class. In this case only a subset of all objects from the foreign class are shown as options, only those that are valid within the present context. The same rule as above is applied to define whether an object meets the constraints defined by a context.

Furthermore, the context can be used for adding default values for newly defined objects. In this case the class manager will add relations to the objects in the context automatically, as far as there are relations specified from the data class of the new object as connected class (multiplicity *) to the data classes of the objects in the context as foreign class (multiplicity 0.1).

In the application specification it can be defined whether the context has to be applied (or not) in all above cases.

Finally, a context can be used in the execution of computational specifications, such as inference rules or permission rules.

The foundation of the generic application engine is the subject of patent application PCT/NL01/00926 of the inventors of this patent application, which is incorporated herein by reference. In patent application PCT/NL01/00926, the term ‘configuration’ is used which corresponds to the term ‘application specification’ as used in the present patent application. The tern ‘entity’ in PCT/NL01/00926 corresponds to the term ‘data class’ as used in the present patent application; the term ‘attribute’ in PCT/NL01/00926 corresponds to the term ‘field’ as used in the present patent application. The ‘object search’ and ‘object editor’ functionalities as described in PCT/NL01/00926, are integrated in the ‘class manager’. A ‘context’ is now understood to comprise an ordered list of all objects which were passed by the user to arrive at the present object (via several class managers), plus the indication of the relationships between the objects.

For the technical implementation of the generic application engine, two strategies can be chosen:
Strategy 1 is interpretation. In this case the application specification is loaded into the generic application engine. The generic application engine interprets the content of the application specification, and shows the desired behaviour to the outside world.
Strategy 2 is compilation. In this case the application specification is loaded into the generic application engine. The generic application engine first reads the content of the application specification, and compiles (parts of) the application specification to executable program code, that will run together with standard components of the generic application engine.
   The pros and cons of these strategies are well known in the field op data processing, and therefore not further described in this document.

An example of the present system and method for building a software application is given below. The example shows how to develop a reservation application for (holiday) house rentals, in which private home owners offer their homes via a local agent. The software application has to support this via the Internet.

The software application is realised using the specification editor 4. First, the software application is given a name, and some general characteristics are given. In a second step, the data classes are specified. From an information analysis, the following data classes are found in the rental process:
Homes
   Data concerning the homes, such as the address, number of persons allowed, a picture, the owner, etc.
Rentals
   Data concerning the rental periods during which the home is available, as well as the rental cost and whether the home is rented during a specific period.
Persons
   Data related to the various actors in the process. These include name and address data, but also role indication, user names and passwords.

The next step is to specify the fields and domains of the various data classes. For each field, a name, data type, description, input instructions and domain or foreign class (when relevant) is indicated. Then, for each data class, the following is specified: the mutual order of the fields, the primary show field, which fields can be used as primary (P) or secondary (S) selection criteria, which fields must be shown in a table after a select action, which fields are used for sorting the table (ascending or descending), which fields are mandatory, and in which categories the fields must be presented.

For the data class ‘Homes’ this results in the following entry in the regular specification 7. Note that not all field characteristics are shown.

| | | select | show in | | | | foreign | |
|---|---|---|---|---|---|---|---|---|
| field name | data type | field? | table? | sort | mandatory | domain | class | category |
| Reference number | Integer | | | | V | | | Core data |
| Name | String | S | Y | | V | | | Core data |
| Picture | Graphic | | Y | | | | | Core data |
| Short description | String | | Y | | V | | | Core data |
| Description | Memo | | | | | | | Core data |
| Max. no. persons | Integer | P | Y | A | V | Number | | Core data |
| No. bed rooms | Integer | S | | | V | Number | | Core data |
| Distance to town (km) | Integer | S | | | | | | Add. info |
| Child friendly | Boolean | S | | | | | | Add. info |
| Price starting from | Currency | S | | | | Price | | Add. info |
| Street | String | | | | V | | | Address |
| Zip code + City | String | | | | V | | | Address |
| Country | String | P | Y | A | V | Countries | | Address |
| Tel. Agent | Integer | | | | V | | | Contact data |
| Agent | Integer | S | | | V | | Persons | Contact data |
| Owner | Integer | S | | | V | | Persons | Contact data |

‘Reference number’ is indicated as the unique key field, ‘Name’ as primary show field. The fields ‘Price starting from’ and ‘Tel. agent’ are deduced fields, which are deduced using a computational specification 8.

The domain ‘Countries’ comprises all relevant countries, e.g.:

countries

| | |
|---|---|
| NL | Netherlands |
| BE | Belgium |
| NA | Namibia |
| BA | Brazil |

The domain ‘Price’ is a continuous domain, like ‘500, cheap’, ‘1000, average’ and ‘1500, expensive’. This provides the possibility to let users create selection criteria based on the three labels, but presenting all results, ordered on the closeness of the match.

In the field ‘Agent’ a dynamic lookup is defined as a computational specification, as it is meant that only agents are shown which have indicated to be active in a specific country.

For the data class ‘Homes’ four categories with content type ‘fields’ are specified: ‘Core data’, ‘Add. info’, ‘Address’ and ‘Contact data’. Furthermore one category ‘Rentals’ is specified. This category has content type ‘connected objects’ and ‘Rentals’ as content class. As a result, all rentals related to a home, will be presented in a table on a tab panel.

As a next step, user groups are specified. From a further analysis of the actors, the following user groups are identified:
Customers
Owners
Agents
Manager

As the next step, the permissions for user groups and data classes are specified. (Export and copy permissions are omitted in this example.)

| | Homes | | | | | Rentals | | | | | Persons | | | | |
|---|---|---|---|---|---|---|---|---|---|---|---|---|---|---|---|
| | insert | delete | select | read | update | insert | delete | select | read | update | insert | delete | select | read | update |
| a) Customers | N | N | Y | C | N | Y | N | N | F | N | O | N | O | O | O |
| b) Owners | O | O | Y | C | O | N | N | O | F | N | O | N | O | O | O |
| c) Agents | O | O | Y | C | O | O | O | O | F | O | O | N | O | O | O |
| d) Manager | Y | Y | Y | Y | Y | Y | Y | Y | Y | Y | Y | Y | Y | Y | Y |

legend:
Y = yes
N = no
F = follow foreign object
O = own
C = constraint

For the user group ‘Customers’ it is indicated that they are allowed to select objects from the data class ‘Homes’ and that they are allowed to view data related to these objects. On field level it may be indicated which fields from these data classes they are not allowed to use as a selection criterion or which they are not allowed to view. Customers are not allowed to see homes in the database which are marked ‘screened off. This is specified in a computational specification in the form of a constraint. As a consequence, customers are also not allowed to read rentals related to the homes that are screened of. This is expressed by a follow foreign object permission value. Customers may also insert reservations. Customers may also insert, read and update their own data.

For the user group ‘Owners’ the sane permission rights are specified as for the ‘Customers’. Moreover, they are allowed to read all homes, to insert homes, to delete homes, and to update data concerning homes, but only for their own homes. The generic application engine knows from the data model that there are relations from the data class ‘Homes’ to the data class ‘Persons’ (via the fields ‘Agent’ and ‘Owner’). If the current user actually is related to the current home, the generic application engine grants the user the additional permissions. Furthermore, on a field level it may be indicated which fields may not be updated. Owners are also allowed to select rentals, but again, only their own.

For the user group ‘Agents’ the same permissions are defined as for the user group ‘Owners’. Moreover, they are allowed to add or delete objects in the data class ‘Rentals’, but only for the homes of owners they represent.

For the user group ‘Manager’ it is indicated that they have all permissions for each data class, allowing the ‘manager’ to select, read, insert, delete and update data in all data classes.

As a next step, triggers may be entered, defined in the form of macro's. This software application has two triggers:
Once a customer makes a reservation, an e-mail must be sent to the associated agent.
Once the agent confirms the reservation, an e-mail must be sent to the customer and (when desired) to the owner.

Next, validation rules may be entered in the application specification, relating to constraints for input data, e.g. check for double rental in a certain period. These validation rules may have the form of a flow chart in the computational specification.

After finishing the specification of data classes and fields, the generic application engine is able to build a database 6 which suits the application specification just developed.

As a final step, the default layout may be altered to a desired layout using the appearance specification 9.

Using this procedure, it is possible to have a working software application within a very limited amount of time. As soon as fields are specified, it is possible to test whether the software application suits the requirements, by entering the application specification in the generic application engine and review the running software application. New ideas or possibilities may be directly included in the application specification, tested and allowed or dismissed.

1. System for executing a software application comprising
A computer system connected to a plurality of input/output interfaces (11-14) and a database (6),
The computer system being arranged for implementing a generic application engine (5) and for receiving an application specification (10) as input for the generic application engine (5),
Which generic application engine (5) is connected to the plurality of input/output interfaces and to the database (6), the generic application engine (5) being arranged to use a set of functional components, such as database operations, logical operations, presentation functions, user input/output interfaces, logging and monitoring, to convert the application specification (10) into the software application,
The application specification( 0) comprising:
a) a specification of a plurality of data classes, a data class being a description of objects relevant within the software application, and the plurality of data classes forming a structure by means of relations;
b) a specification of at least one user group of the software application, a user group being defined as a group of users having common roles with regard to the software application; and
c) an assignment of permissions to the at least one user group with respect to the plurality of data classes.

2. System according to claim 1, in which a data class hierarchy is defined in the application specification by specifying an extended data class as comprising one or more inherited characteristics of an associated super data class.

3. System according to claim 1, in which the application specification (10) further comprises for each of the plurality of data classes a specification of a plurality of fields, each field representing an element for storing data values relating to an object.

4. System according to claim 3, in which a field hierarchy is defined in the application specification by specifying an extended field as comprising one or more inherited field characteristics of an associated super field.

5. System according to claim 1 in which the application specification (10) further comprises for each of the plurality of data classes a specification of a plurality of categories, which can be used to structure all data related to an object.

6. System according to claim 1, in which the application specification (1) further comprises a specification of a plurality of domains, a domain being a list of lookup values that can be referenced to from the specification of fields.

7. System according to claim 1 wherein the permissions are chosen from the group of: select permission; read permission; update permission; insert permission; copy permission; delete permission.

8. System according to claim 1, wherein the value of each permission is one of the group of: no; yes; follow foreign object; own; constraint.

9. System according to claim 1, wherein the application specification (10) comprises a computational specification (8) for describing further computational or logic functional parts of the software application.

10. System according to claim 1, wherein the application specification (1) comprises an appearance specification (9) for defining non-functional parts of the software application, such as user interface parts.

11. System according to claim 1, wherein the application specification (10) comprises an XML file.

12. System for building a software application comprising an input/output device (22), memory means (21) and processing means (20) connected to the input/output device and memory means, the processing means (2) being arranged for defining an application specification (10), using the input/output device (22), and to store the application specification (10) in the memory means (21), which application specification can be input in a system for executing a software application according to claim 1.

13. Method for executing a software application comprising
Inputting an application specification (10) into a generic application engine (5),
Which generic application engine (5) is connected to a plurality of input/output interfaces and to a database (6), the generic application engine (5) being arranged to use a set of functional components, such as database operations, logical operations, presentation functions, user input/output interfaces, logging and monitoring, to convert the application specification (10) into the software application,
The application specification (10) comprising:
a) a specification of a plurality of data classes, a data class being a description of objects relevant within the software application, and the plurality of data classes forming a structure by means of relations;
b) a specification of at least one user group of the software application, a user group being defined as a group of users having common rules with regard to the software application; and
c) an assignment of permissions to the at least one user group with respect to the plurality of data classes.

14. Method according to claim 13, in which a data class hierarchy is defined in the application specification by specifying an extended data class as comprising one or more inherited characteristics of an associated super data class.

15. Method according to claim 13 wherein the application specification (10) further comprises for each of the plurality of data classes a specification of a plurality of fields, each field representing an element for storing data values related to an object.

16. Method according to claim 15, in which a field hierarchy is defined in the application specification by specifying an extended field as comprising one or more inherited field characteristics of an associated super field.

17. Method according to claim 13, wherein the application specification (10) further comprises for each of the plurality of data classes a specification of a plurality of categories, which can be used to structure all data related to an object.

18. Method according to claim 13, wherein the application specification (10) further comprises a specification of a plurality of domains, a domain being a list of lookup values that can be references to from the specification of fields.

19. Method according to claim 13, wherein the permissions are chosen from the group of select permission; read permission; update permission; insert permission; copy permission; delete permission.

20. Method according to claim 13, wherein the values of each permission is one of the group of: no; yes; follow foreign object; own; constraint.

21. Method according to claim 13, wherein the application specification (10) further comprises a computational specification (8) for describing further computational or logic functional parts of the software application.

22. Method according to claim 13, wherein the application specification (10) further comprises an appearance specification (9) for defining non-functional parts of the software application, such as user interface parts.

23. Method according to claim 13, wherein the application specification (10) is stored as an XML file.

24. Method for building a software application comprising
Defining an application specification (10) and storing the application specification (10), which application specification is arranged to be used in a method for executing a software application according to claim 12.

25. Computer program product comprising computer readable code, which allows a computer when loaded with the computer readable code to implement a generic application engine (5) as used in the system according to claim 1.

26. Computer program product comprising computer readable code, which allows a computer when loaded with the computer readable code to define an application specification (10) which is adapted to be entered in a generic application engine (5) running on the computer, the application specification comprising:
a) a specification of a plurality of data classes, a data class being a description of objects relevant within the software application, and the plurality of data classes forming a structure by means of relations;
b) a specification of at least one user group of the software application, a user group being defined as a group of users having common rules with regard to the software application; and
c) an assignment of permissions to the at least one user group with respect to the plurality of data classes.
